(19) United States
(12) Patent Application Publication
(10) Pub. No.: US 2008/0034996 A1
(43) Pub. Date: Feb. 14, 2008

(54) Print system, method for controlling printer, and computer readable medium

(75) Inventor: Yoshikazu Yamamoto, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/730,146

(22) Filed: Mar. 29, 2007

(30) Foreign Application Priority Data
Aug. 14, 2006 (JP) 2006-220944

(51) Int. Cl. B41F 13/02

(52) U.S. Cl. 101/225

(57) ABSTRACT

A print system includes: a first printing device; a second printing device; a host machine; and a storage device, wherein the first printing device and the second printing device, which receive a print command from the host machine, continuously transport a continuous sheet even after printing operation complying with a received print command has been completed, and resume printing operation from a state where the continuous sheet is being transported, upon receipt of a next print command from the host machine before completion of transport of the object of accommodating to the storage device.

### CROSS-REFERENCE TO RELATED APPLICATIONS

This application is based on and claims priority under 35 U.S.C. 119 from Japanese Patent Application No. 2006-220944 filed Aug. 14, 2006.

### BACKGROUND

### Technical Field

The present invention relates to a print system, a method for controlling a printer, and a computer readable medium.

### SUMMARY

According to a first aspect of the present invention, a print system including: a first printing device that transports a continuous sheet, which is an object of printing, and that prints an image on the continuous sheet; a second printing device that transports the continuous sheet discharged from the first printing device, and that prints an image on the continuous sheet; a host machine that issues a print command to the first printing device and the second printing device; and a storage device that accommodates, as an object of accommodating, the continuous sheet discharged from the second printing device or a portion separated from the continuous sheet, wherein the first printing device and the second printing device, which receive a print command from the host machine, continuously transport the continuous sheet even after printing operation complying with the received print command has been completed, and resume printing operation from a state where the continuous sheet is being transported, upon receipt of a next print command from the host machine before completion of transport of the object of accommodating to the storage device.

### BRIEF DESCRIPTION OF THE DRAWINGS

Exemplary embodiment of the present invention will be described in detail based on the following figures, wherein;

FIG. 1 is a schematic diagram showing a print system according to a mode of an embodiment;

FIG. 2 is a schematic diagram for describing a front surface printing device;

FIG. 3 is a block of a control section of the front surface printing device;

FIG. 4 is a flowchart for describing processing procedures of the printing device;

FIG. 5 is a timing chart of the print system of the mode of the embodiment;

FIG. 6 is a view for describing a position where printing is commenced when printing operation is resumed; and

FIG. 7 is a view for describing a position where printing is commenced when printing operation is resumed.

### DETAILED DESCRIPTION

A mode embodying the present invention will be described hereunder by reference to the accompanying drawings.

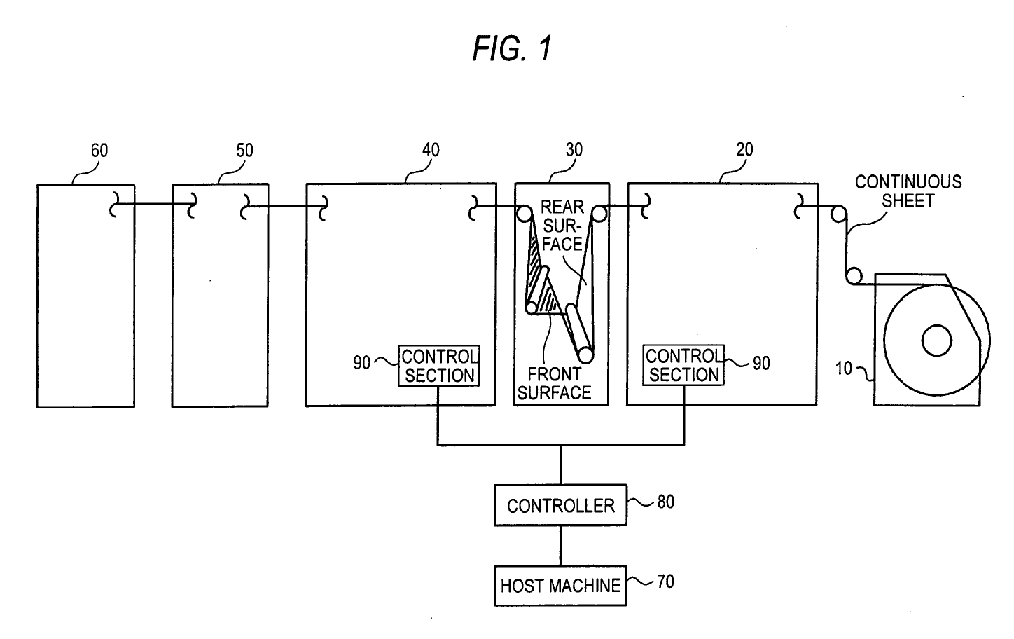

FIG. 1 is a schematic diagram showing a print system according to the mode of the present embodiment.

As shown in FIG. 1, the print system comprises a sheet feeder 10 for supplying a continuous sheet (a rolled sheet) which is an object of printing; a front surface printing device (an image forming apparatus, a first printing device, print means, and transport means) 20 for printing a front surface of the continuous sheet supplied from the sheet feeder 10; and a rear surface printing device (an image forming apparatus, a second printing device, print means, and transport means) 40 for printing a rear surface of the continuous sheet whose front surface has been printed by the front surface printing device 20. The front surface printing device 20 and the rear surface printing device 40 are arranged in series with reference to the continuous sheet. The front surface printing device 20 and the rear surface printing device 40 are disposed while being separated from each other. Although in the present embodiment the print system has two printing devices 20 and 40, another conceivable configuration of the print system may have a number of printing devices larger than two.

Each of the front surface printing device 20 and the rear surface printing device 40 has a control section (control means) 90. This control section 90 receives a print command from a host machine 70 by way of a controller 80 and controls operations of individual sections of the printing devices 20 and 40. The control section 90 comprises an unillustrated microcomputer consisting of a CPU, ROM, and RAM.

The print system additionally has a front-to-rear surface inversion device 30 which is interposed between the front surface printing device 20 and the rear surface printing device 40 and inverts the front surface of the continuous sheet to the rear surface. Specifically, the front-to-rear surface inversion device 30 inverts the front surface of the continuous sheet into the rear surface from the front surface printing device 20 to the rear surface printing device 40.

The print system has a medium-processing section 50 for cutting the continuous sheet having passed through the front surface printing device 20 and the rear surface printing device 40, to thus create a finished sheet; and a stacking section 60 for housing the finished sheets processed by the medium-processing section 50. In addition to including a mode for cutting a continuous sheet into a single sheet by means of a blade, the finished sheet to be housed in the stacking section 60 includes another conceivable mode of collapsing a perforated sheet, which can be separated into a single piece of paper, along a perforation.

In order to subject an area in the rear surface corresponding to an area of the front surface printed by the front surface printing device 20 to printing performed by the rear surface printing device 40, transport of the continuous sheet is continued. Specifically, even after having completed printing operation in accordance with the print command from the host machine 70, the front surface printing device 20 continues transport of the continuous sheet. After the rear surface printing device 40 has made a print on the rear surface, the front surface printing device 20 and the rear surface printing device 40 continue transport of the continuous sheet in unmodified form. Thus, the final page printed in accordance with the print command is processed by the medium-processing section 50 and housed in the stacking section 60.

As mentioned above, the print system is configured so as to subject a single print medium to double-sided printing through use of a plurality of printing devices (i.e., the front surface printing device 20 and the rear surface printing device 40). In short, the print system is configured so that a specified page defined on the continuous sheet can be subjected to double-sided printing by means of two printing devices (i.e., the front surface printing device 20 and the rear surface printing device 40) connected in series. After the continuous sheet has been printed by means of the two printing devices (i.e., the front surface printing device 20 and the rear surface printing device 40), the sheet is cut into a predetermined size (e.g., A4-size), and the thus-cut sheet is housed as a finished sheet.

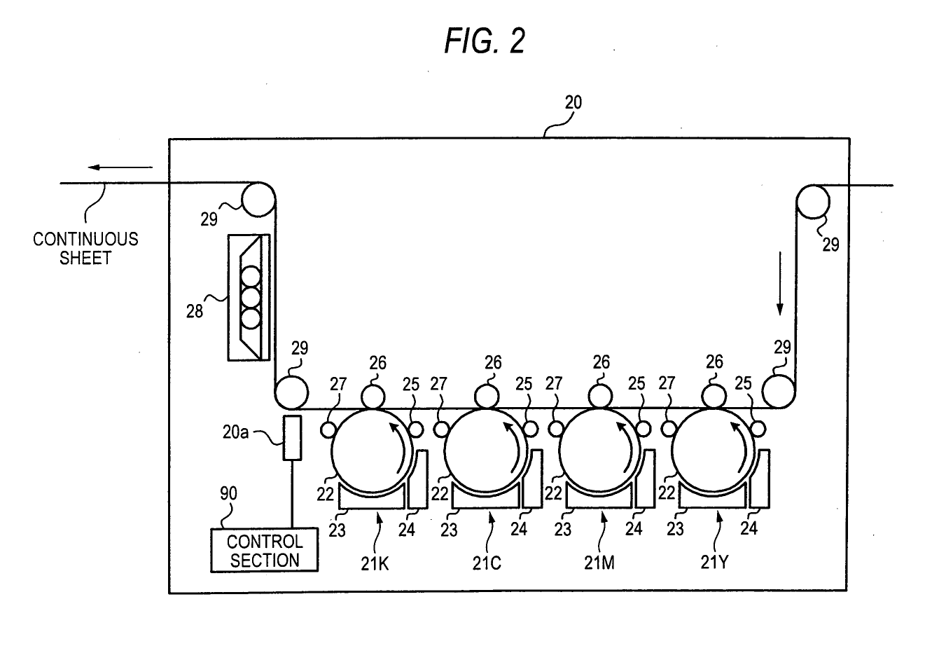

FIG. 2 is a schematic diagram for describing the front surface printing device 20. Since the front surface printing device 20 and the rear surface printing device 40 are of the same structure, only the front surface printing device 20 is described, and description of the rear surface printing device 40 is omitted.

The front surface printing device 20 shown in FIG. 2 is of so-called tandem type. The front surface printing device 20 comprises a plurality of image forming units 21Y, 21M, 21C, and 21K around which toner images of respective color components are formed by means of, e.g., electrophotography; and a fixing section 28 for fixing, to the continuous sheet, the toner images of respective color components sequentially transferred onto the continuous sheet formed by the respective image forming units (image stations and printer engines) 21Y, 21M, 21C, and 21K. The front surface printing device 20 has a plurality of transport rollers 29 used for transporting the continuous sheet in a transporting direction.

Each of the image forming units 21Y, 21M, 21C, and 21K has a photosensitive drum 22, an electrifying device 23, a laser exposure device 24, a development device 25, a transfer section 26, and a drum cleaner 27. When the host machine 70 (see FIG. 1) has output the print command to the control section 90, the control section 90 performs predetermined image processing. The image data having undergone image processing are converted into coloring material gradation data of four colors: yellow (Y), magenta (M), cyan (C), and black (K). The coloring material gradation data are output to the respective laser exposure devices 24 of the image forming units 21Y, 21M, 21C, and 21K.

After the surfaces of the photosensitive drums 22 in the respective image forming units 21Y, 21M, 21C, and 21K have been electrified by the electrifying devices 23, the surfaces are subjected to scan-exposure performed by the laser exposure devices 24, whereby electrostatic latent images are created. The thus-created electrostatic latent images are developed as toner images of respective colors; namely, yellow, magenta, cyan, and black, by means of the respective image forming units 21Y, 21M, 21C, and 21K.

The toner images created on the respective photosensitive drums 22 are sequentially transferred and superimposed onto the continuous sheet by means of the respective transfer sections 26. The speed of the continuous sheet on which the toner images have been transferred by the respective transfer sections 26 is changed in accordance with a transport speed optimum for the fixing section 28, and the continuous sheet is transported to the fixing section 28. Unfixed toner images on the continuous sheet are subjected to fixing performed by the fixing section 28 by means of heat and pressure and fixed on the continuous sheet. The continuous sheet on which the fixed images are created is discharged outside of the front surface printing device 20 by means of the transport rollers 29.

Meanwhile, the toner still remaining on the respective photosensitive drums 22 after completion of transfer of the images onto the continuous sheet is transported to the drum cleaners 27 in association with rotation of the photosensitive drums 22 and wiped away from the surfaces of the respective photosensitive drums 22 by means of the drum cleaners 27.

The front surface printing device 20 has a detection section 20a disposed at a position downstream of the image forming units 21Y, 21M, 21C, and 21K. This detection section 20a detects registration marks of respective colors created by the image forming units 21Y, 21M, 21C, and 21K, and outputs results of detection as signals to the control section 90. In accordance with the results of detection acquired from the detection section 20a, the control section 90 controls timings at which electrostatic latent images are created on the respective photosensitive drums 22 of the image forming units 21Y, 21M, 21C, and 21K.

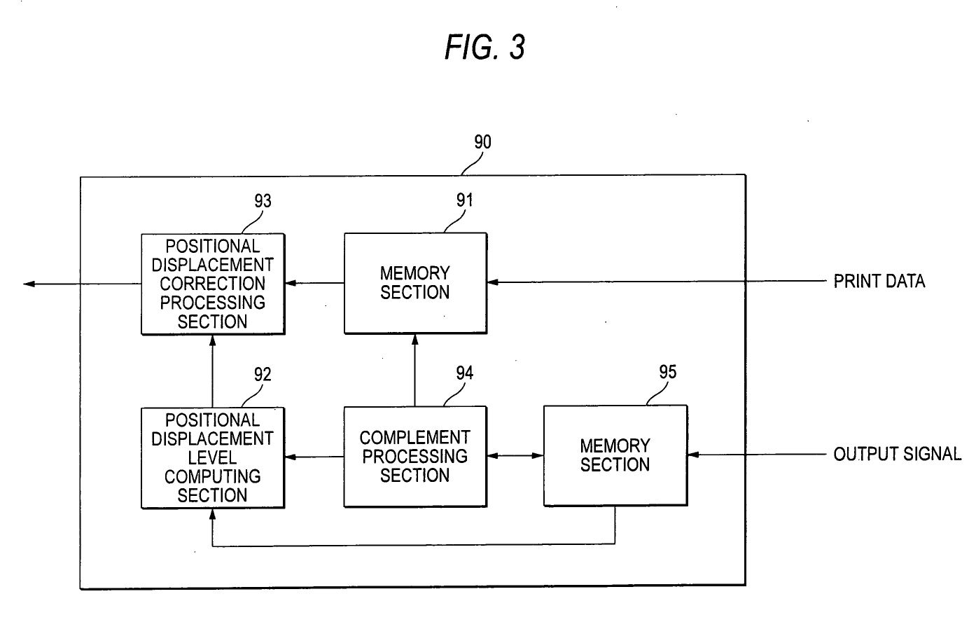

FIG. 3 is a block diagram of the control section 90 of the front surface printing device 20.

As shown in FIG. 3, the control section 90 comprises a memory section 91, a positional displacement level computing section 92, a positional displacement correction processing section 93, a complement processing section 94, and a memory section 95. By means of these sections, a print position automatic adjustment function is implemented.

The memory section 91 is for storing a print command including print data input by the host machine 70 by way of the controller 80. The positional displacement level computing section 92 is for computing the amount of displacements of the center position of a currently-detected registration mark in both the main scanning direction and the sub-scanning direction with reference to the center position of a previously-detected registration mark. The positional displacement correction processing section 93 is for performing correction operation to correct a displacement in the scan position. Here, the term “correction operation” is for performing mechanical or electrical correction according to the amount of displacement computed by the positional displacement level computing section 92.

The complement processing section 94 determines a deficiency of a registration mark from a result of detection of the registration mark performed by the detection section 20a and complements an output signal so as to become identical with an output signal showing a normal registration mark. The memory section 95 stores in advance an output signal showing a normal registration mark. This reference output signal is an ideal output signal showing a registration mark to be detected this time while taking as a reference the center position of the previously-detected registration mark.

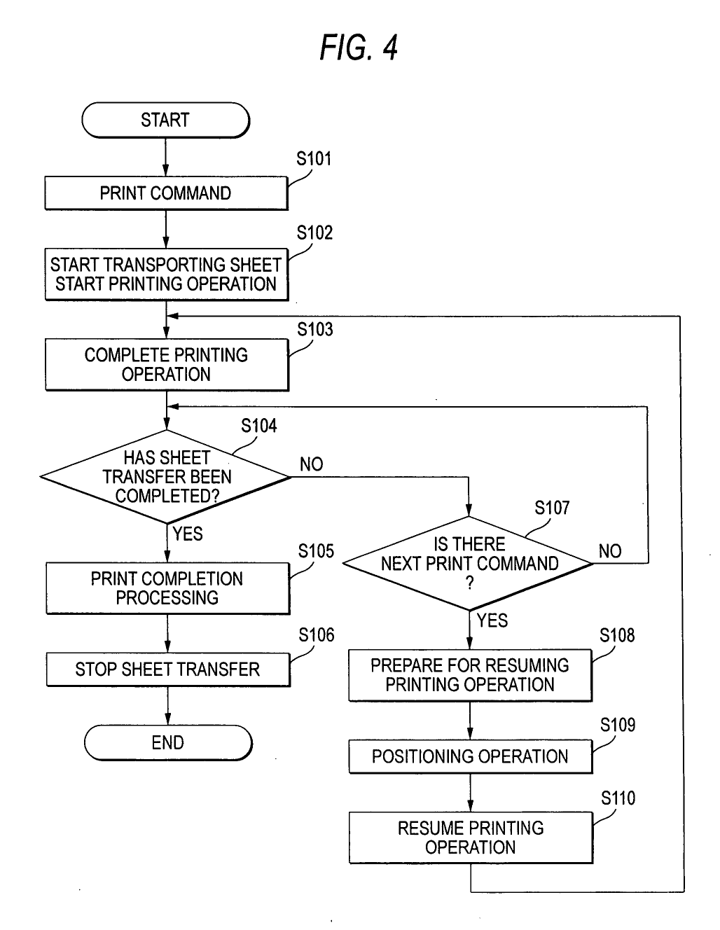

FIG. 4 is a flowchart for describing processing procedures of the printing devices (i.e., the front surface printing device 20 and the rear surface printing device 40).

As shown in FIG. 4, upon receipt of a print command from the host machine 70 (see FIG. 1) (step 101), the control section 90 causes the sheet feeder 10 (see FIG. 1) to initiate transport of a continuous sheet and commences printing operation (step 102). After printing operation complying with the print command has been completed (step 103), the control section 90 determines whether or not the transport of the continuous sheet has already been completed (step 104). Specifically, the control section 90 determines whether or not the final page having passed through the printing devices (i.e., the front surface printing device 20 and the rear surface printing device 40) is housed in the stack section 60 (see FIG. 1).

Various configurations for causing the control section 90 to render such a determination are conceivable. For instance, the control section 90 acquires information about the number of sheets housed in the stack section 60, and compares the information with information about the number of sheets printed through printing operation, thereby determining whether or not the final page has been housed in the stack section 60. Unillustrated detection means detects a distance over which the continuous sheet is transported from the final page and outputs a signal to the control section 90, thereby determining whether or not the final page is housed in the stack section 60. Unillustrated counting means measures a time having elapsed since completion of printing operation and outputs a signal to the control section 90, whereby the control section can determine whether or not the final page is housed in the stack section 60.

When the control section 90 has determined, in step 104, that transport of the continuous sheet has been completed, performs control operation so as to stop sheet transfer operation (step 10G) after having subjected the sheet to print complete processing (step 105). Here, the term “print complete processing” means processing performed when printing operation is stopped; for instance, processing for continuing rotation of the photosensitive drums 22 for a while after the electrifying devices 23 (see FIG. 2) have been deactivated.

Meanwhile, when the control section 90 has determined, in step 104, that transport of the continuous sheet has not yet been completed, the control section 90 further renders a determination as to whether or not the next print command has been received (step 107). When the control section 90 has determined that the next print command has not been received, processing returns to step 104.

When the control section 90 has determined that the next print command has been received, preparation for resuming printing operation is made (step 108). Here, the term “preparation for resuming printing operation” means performance of processing for resuming printing operation, in accordance with predetermined procedures, from a state where the printing operation has been completed and sheet transfer is being performed; for example, processing for setting a timing at which the surfaces of the photosensitive drums 22 are subjected to scan exposure performed by the laser exposure devices 24 (see FIG. 2).

After preparation for resuming printing operation, the control section 90 performs control operation such that the respective image forming units 21Y, 21M, 21C, and 21K (see FIG. 2) are mutually positioned (step 109). This positioning operation is performed by use of the above-described registration mark. After positioning operation has been completed, printing operation is resumed (step 110). Thus, printing operation is resumed without stopping transport of the sheet. After resumption of printing operation, processing returns to step 103.

In the print system of the present embodiment, when sheet transfer is stopped in step 10G, operation for causing the continuous sheet to recede in preparation for printing the next page is not performed.

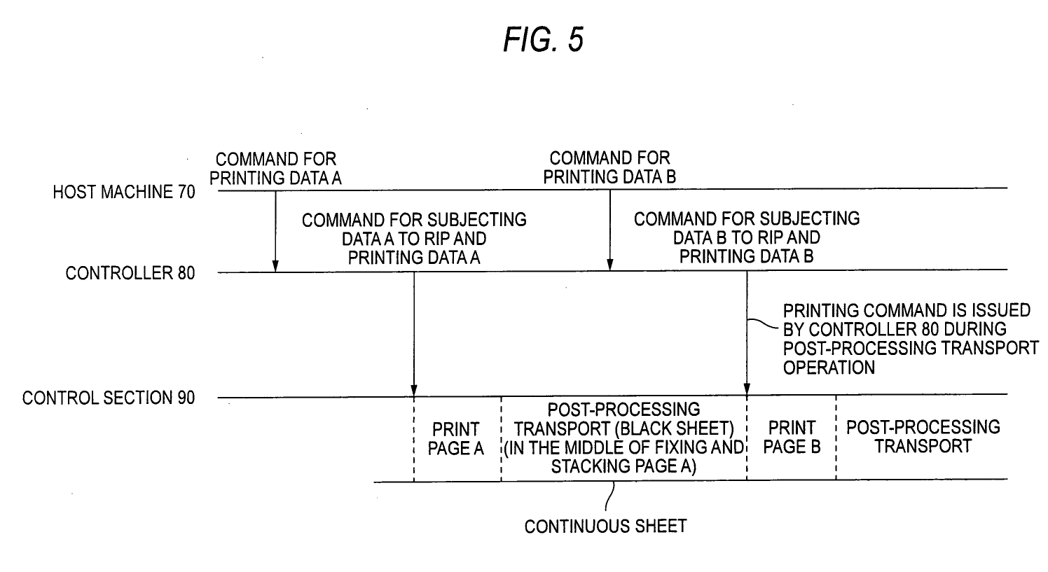

FIG. 5 is a timing chart of the print system of the present embodiment for specifically describing overall processing procedures of the flowchart shown in FIG. 4.

As shown in FIG. 5, when the host machine 70 issues a command for printing data A to the controller 80, the controller 80 subjects the data A to RIP (Raster Image Processing). Specifically, the controller 80 interprets a command and a PDL (Page Description Language) in connection with the data A from the host machine 70, to thus generate a bitmap to be output by the front surface printing device 20 and the rear surface printing device 40; and converts the data into a raster image. After completion of RIP, the controller 80 sends the data to a control section 90 of the front surface printing device 20 and a control section 90 of the rear surface printing device 40. As a result, the control section 90 of the front surface printing device 20 and the control section 90 of the rear surface printing device 40 control individual sections such that page A is printed on both sides of a continuous sheet.

As mentioned previously, even after completion of the printing operation including fixing operation, the front surface printing device 20 and the rear surface printing device 40 transport the continuous sheet (post-processing transport operation and preliminary transport operation). Such post-processing transport operation is continued until the final page is housed as a finished page into the stack section 60.

Upon receipt of the print command from the host machine 70 by way of the controller 80 during the course of post-processing transport of the continuous sheet, the front surface printing device 20 and the rear surface printing device 40 immediately shift to printing operation from the transporting state. Namely, when a command for printing data B is issued from the host machine 70 via the controller 80 to the front surface printing device 20 remaining in a transported state and the rear surface printing device 40, printing operation is resumed without stopping sheet transfer operation, and processing proceeds to operation for printing data B.

As above, when the next print command has been received during the course of post-processing transport operation, the front surface printing device 20 and the rear surface printing device 40 resume printing operation without stopping sheet transfer operation. Here, the page A and the page B are used not to specify a number of page to be printed and imply a case where the number of pages to be printed is one or plural.

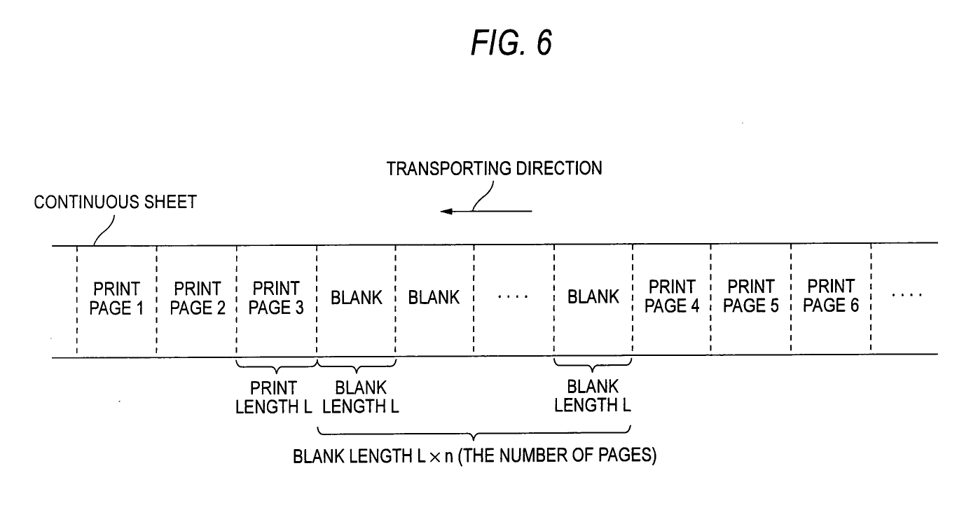

FIG. 6 is a view for describing a print start position achieved when the printing operation is resumed.

As mentioned previously, when the next print command has been issued during the transport of the continuous sheet, preparation for resuming printing operation is made (see step 108 shown in FIG. 4). At that time, the print start position can be adjusted. More specifically, printing of an image on the continuous sheet performed when printing operation is resumed is started from a position corresponding to a distance which is an integral multiple of the print length of a preceding page. For instance, provided that the first print command is a request for printing images on page 1 to page 3 and that the next print command is a request for printing images on page 4 to page 6, a plurality of blanks (Blank) are formed between pages 3 and 4. In more detail, the control section 90 controls a position where printing of page 4 is started such that the distance between the pages 3 and 4 assumes a value which is a product made by multiplying a blank length L by an integer “n.” The blank length L assumes the same value as that assumed by the print length L.

The plurality of blanks are cut into white sheets by the medium processing section 50, and the white sheets are housed as purged sheets (waste sheets) separately from finished pages in the stack section 60 (see FIG. 1).

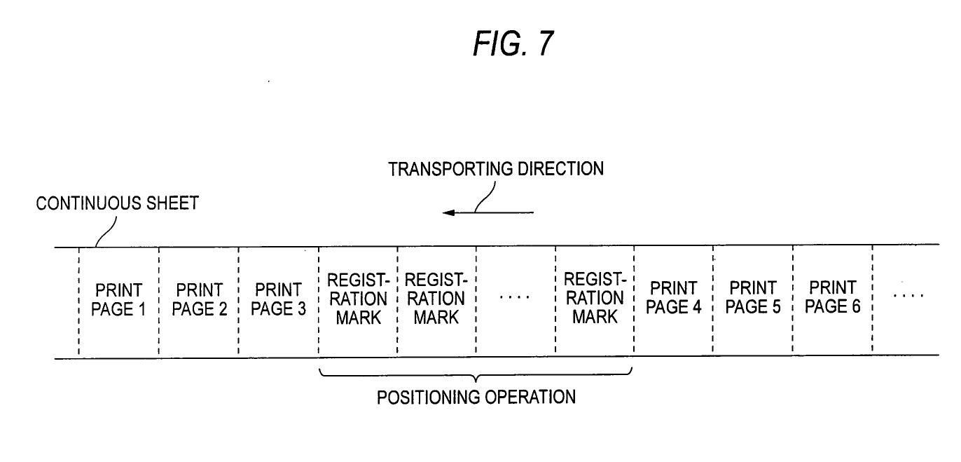

FIG. 7 is a view for describing a position where printing operation is started when the printing operation is resumed.

In the continuous sheet shown in FIG. 7, registration marks used for positioning the image forming units 21Y, 21M, 21C, and 21K are printed in a blank between pages 3 and 4 of continuous sheets. Specifically, the front surface printing device 20 and the rear surface printing device 40 are positioned during the course of post-processing transport operation. The blank located between the pages 3 and 4 of the continuous sheets is handled as a purged sheet, and hence positioning is performed by utilization of the blank. A timing at which positioning is performed is any time achieved during the transport of the continuous sheet after printing operation. A conceivable configuration is to perform positioning for printing after the next print command has been received during transport of the continuous sheet.

The control section 90, which has detected cancellation of the printing operation when sheet transport is being continued, performs control operation so as to stop sheet transport immediately even during the course of positioning operation.

What is claimed is:

1. A print system comprising:
a first printing device that transports a continuous sheet, which is an object of printing, and that prints an image on the continuous sheet;
a second printing device that transports the continuous sheet discharged from the first printing device, and that prints an image on the continuous sheet;
a host machine that issues a print command to the first printing device and the second printing device; and
a storage device that accommodates, as an object of accommodating, the continuous sheet discharged from the second printing device or a portion separated from the continuous sheet,
wherein
the first printing device and the second printing device, which receive a print command from the host-machine, continuously transport the continuous sheet even after printing operation complying with the received print command has been completed, and resume printing operation from a state where the continuous sheet is being transported, upon receipt of a next print command from the host machine before completion of transport of the object of accommodating to the storage device.

2. The print system as claimed in claim 1,
wherein
the first printing device transports a continuous sheet, which is an object of printing and prints an image on one surface of the continuous sheet, and
a second printing device transports the continuous sheet discharged from the first printing device and prints an image on an opposite surface of the one surface of the continuous sheet.

3. The print system as claimed in claim 1, wherein the first printing device and the second printing device resume printing operation such that a print start position is spaced from an area on the continuous sheet, where an image has finally been created, by a distance corresponding to an integral multiple of a print length of the printed area.

4. The print system as claimed in claim 1, wherein the first printing device and the second printing device have a function of enabling adjustment of a print position and adjust the print position during the course of transport of the continuous sheet performed after completion of printing operation complying with the print command.

5. The print system as claimed in claim 1, wherein the first printing device and the second printing device have a function of enabling adjustment of a print position, and adjust the print position upon receipt of a print command during the course of transport of the continuous sheet performed after completion of the printing operation complying with the print command.

6. The print system as claimed in claim 5, wherein, in a case where the first printing device and the second printing device, which are in the middle of adjustment of the print position, have received a command for canceling the received print command, the first printing device and the second printing device stop transport of the continuous sheet.

7. The print system as claimed in claim 1, wherein the storage device accommodates the separated portion as an object of accommodating, and separately accommodates a portion of the separated portion printed in accordance with the print command and a non-print portion other than the printed portion.

8. A print system comprising:
a transport section that transports a continuous sheet;
a print section that is formed from a plurality of printing is devices arranged in a direction along which a continuous sheet is transported by the transport section, and that subjects the continuous sheet transported by the transport section to printing; and
a control section that controls the transport section and the print section,
wherein
the control section performs control operation in such a manner that transport of the continuous sheet performed by the transport section is completed at a predetermined point in time after completion of printing operation complying with the received print command, and that the print section resumes printing operation without stopping transport of the continuous sheet performed by the transport section in a case where a next print command has been received before the predetermined point in time.

9. The print system as claimed in claim 8, wherein the control section controls printing operation in such a way that a print start position, where printing operation is resumed, of the print section becomes spaced from an area, where an image has finally been created, on the continuous sheet, by an amount corresponding to an integral multiple of a print length of the printed area.

10. The print system as claimed in claim 8,
wherein
the print section has a function of enabling adjustment of the print position, and
the control section controls the print section in such a way that the print position is adjusted during the course of transport of the continuous sheet performed after completion of the printing operation complying with the print command.

11. The print system as claimed in claim 8,
wherein
the print section has a function of enabling adjustment of the print position, and
the control section controls the print section in such a way that the print position is adjusted, when having received a print command during the course of transport of the continuous sheet performed after completion of the printing operation complying with the print command.

12. The print system as claimed in claim 11, wherein the control section stops transport of the continuous sheet performed by the transport section in a case where having received a command for canceling the print command having already been received by the print section which is in the middle of adjustment of the print position.

13. A method for controlling a printing device, which controls each of a plurality of printing devices arranged at intervals along a direction along which a continuous sheet is fed, the method comprising:
continually transporting the continuous sheet even after printing operation complying with the received print command complete; and
resuming printing operation for resuming transport of the continuous sheet without stopping transport of the continuous sheet in a case where a new print command is received before a point in time the continuous sheet, which is continually being transported, is stopped when there is no subsequent print command.

14. A computer readable medium storing a program causing a computer to execute a process for controlling each of a plurality of printing devices arranged at intervals along a direction along which a continuous sheet is fed, the process comprising:
continually transporting the continuous sheet even after printing operation complying with the received print command complete; and
resuming printing operation for resuming transport of the continuous sheet without stopping transport of the continuous sheet in a case where a new print command is received before a point in time the continuous sheet, which is continually being transported, is stopped when there is no subsequent print command.
